(19) United States
(12) Patent Application Publication
(10) Pub. No.: US 2009/0094039 A1
(43) Pub. Date: Apr. 9, 2009

(54) COLLABORATIVE PRODUCTION OF RICH MEDIA CONTENT

(75) Inventors: Eric MacDonald, Exeter, NH (US); Orion Reblitz-Richardson, Boston, MA (US)

Correspondence Address: FISH & RICHARDSON PC, P.O. BOX 1022, MINNEAPOLIS, MN, 55440-1022, US

(73) Assignee: Zhura Corporation, Boston, MA (US)

(21) Appl. No.: 11/867,109

(22) Filed: Oct. 4, 2007

(51) Int. Cl. G06Q 10/00; G06F 15/16; G06F 3/048

(52) U.S. Cl. 705/1; 709/201; 709/205; 715/716

(57) ABSTRACT

Among other things, a publicly accessible online facility enables users to create finished rich media content (RMC) by collaboratively engaging in activities to create RMC portions related to the finished RMC, the RMC portions being made accessible to the users in different predefined levels of abstraction in which the finished RMC can be expressed.

### TECHNICAL FIELD

This disclosure relates to collaborative production of rich media content.

### BACKGROUND

Video sharing websites, such as youtube.com, provide platforms where users can upload, view, and share video clips with other users. Some of these websites provide tools that allow users to post comments regarding a video or rank videos according to a preference scale.

The production of rich media works often requires the participation and cooperation of many parties, including writers, editors, camera operators, producers, and others. The work typically proceeds over a period of time with drafts and partially complete work passed back and forth among the participants.

### SUMMARY

In general, in an aspect, a publicly accessible online facility enables users to create finished rich media content (RMC) by collaboratively engaging in activities to create RMC portions related to the finished RMC, the RMC portions being made accessible to the users in different predefined levels of abstraction in which the finished. RMC can be expressed.

Implementations may include one or more of the following. The online facility also enables the users to compete and engage in social networking with respect to the creation of the RMC portions. The levels of abstraction include ideas and expressions of the ideas in forms that are not finished RMC. The expressions of the ideas include at least one of scripts, essays, song lyrics, and speeches. Each of at least one of the elements that belongs to a higher level of abstraction is associated with one or more element at a lower level of abstraction. One of the elements that belongs to a lower level of abstraction can be generated using multiple elements at a high level of abstraction.

In general, in an aspect, a hierarchy of RMC portions is made available (to users of a publicly accessible online facility) in two or more predefined abstraction levels associated with RMC, the RMC portions being usable cooperatively by the users to create finished RMC.

Implementations may include one or more of the following. The hierarchy of elements includes ideas, scripts and entertainment productions. Users are enabled to assign rankings to the portions based on the users' preferences and to edit each of the RMC portions. The users are provided with tools to engage in social networking with respect to the creation of the RMC portions and the finished RMC.

In general, in an aspect, an interactive, searchable, ranked repository of ideas is provided through a publicly accessible online facility for use in the creation of RMC.

Implementations may include one or more of the following. The repository stores an idea that is submitted as part of a money-bearing request by an entity for the production of RMC that is based on the idea. An idea and associated information stored in the repository is displayed on a user-interface, the associated information including at least one of an identity of the originator of the idea, a category to which the idea belongs, and portions of RMC that are spawned from the idea. Comments are displayed pertaining to ideas stored in the repository, the comments being submitted by users of the online facility. A financial incentive is provided to users to develop RMC based on an idea stored in the repository.

In general, in an aspect, based on information about activities performed by respective contributors to, and information about portions of RMC, values are calculated representing relative contributions of the contributors, the values are provided for use in compensating the contributors, and the values are provided for use in crediting the contributors.

Implementations may include one or more of the following. Calculating values includes calculating sums of individual contributions of each of the contributors to a portion of RMC; and calculating ratios of the sums to a total sum of individual contributions made by all of the contributors to the RMC portion, the ratios representing the relative contributions of the contributors. The contributors are assigned to multiple groups based on the values associated with the contributors, each of the groups representing a level of contribution to the portion of RMC; and compensation is allocated to contributors based on their assignments to the groups. The groups of contributors comprise major contributors, regular contributors, and minor contributors. Compensation is allocated by allocating portions of the compensation to the groups; and dividing the portions equally between contributors within each of the groups. The portion of RMC is created using a publicly accessible online facility, and a portion of the compensation is allocated to a party that controls the online facility. Credit to contributors for their contributions to the item of rich media content is automatically assigned.

In general, in an aspect, a ranking is published of users of a publicly accessible online facility with respect to their relative performance on types of creative activities, undertaken through the online facility, to produce portions of RMC.

Implementations may include one or more of the following. The ranking comprises numerical scores assigned to the users, the numerical scores corresponding to the number of contributions made by the users within a category of creative activity relative to other users. The ranking of the users indicates the global contribution of each of the users to the online facility across all elements and RMC with respect to a particular creative activity. Sums are calculated of a number of credits assigned to the users for their contributions within a category of the creative activities. The sums are divided by the total number of credits assigned to all users for contributions within that category of creative activity, the ranking being determined based on the results of the dividing. A particular creative activity is: selected from the group consisting of: generating ideas, writing, directing, acting, filming, producing, and singing. The ranking is based on one or more of: the perceived quality and the popularity of the RMC contributed to by the users.

In general, in an aspect, information is made available to users through a publicly accessible online facility, about common elements that can be used in each portion of a group of portions of RMC to be created collaboratively by users of the online facility.

Implementations may include one or more of the following. The elements belong to different predefined levels of abstraction in which the portions of RMC can be expressed. The elements include ideas and expressions of the ideas in forms that are not finished items. The expressions of the ideas comprise at least one of scripts, essays, song lyrics, speeches, audio productions, musical productions, and video productions. Users are enabled to assign rankings to the portions of RMC, to edit the same portion, and to compete with respect to the creation of the portions. Two or more items of the group of portions include alternative versions based on a common element. The users are enabled to engage in social networking, through the online facility, with respect to the creation of the RMC portions.

Advantages may include one or more of the following. An online platform enables users having different talents and interests to collaborate to produce high-quality entertainment fit for any level or type of media outlet. Writers and other participants in the collaborative production of the rich media content can collaborate with peers, e.g., other writers, to improve and polish ideas, scripts, and the finished work. Users can receive feedback from other users on ideas, scripts, and videos. People with raw ideas can share them with the creative community, writers have access to a massive pool of production video personnel, and directors and producers can find an eclectic collection of scripts to produce original entertainment. Writers are provided with tools to control who can edit their work, and film makers are provided with resources to produce high quality short films. A portfolio resume is automatically created for each user who contributes to a creative aspect of a production. Collaboration among many users can be facilitated without respect to geography. A massive talent pool is available to advertisers, producers, etc. Users can find and recruit other talent to work with them on a project.

These and other aspects and features, and combinations of them can be expressed as methods, apparatus, systems, program products, means for performing functions, and in other ways.

Other features and advantages will be apparent from the description and the claims.

### DESCRIPTION OF DRAWINGS

FIGS. 1 and 2 are block diagrams of online collaboration systems.

FIG. 3 is a diagram of a workflow process.

FIG. 4 is a flowchart of a process for creating rich media content (RMC) items.

FIG. 5 is a flowchart of a process for providing RMC items to customers

FIGS. 6-9 are screenshots of user tools.

### DETAILED DESCRIPTION

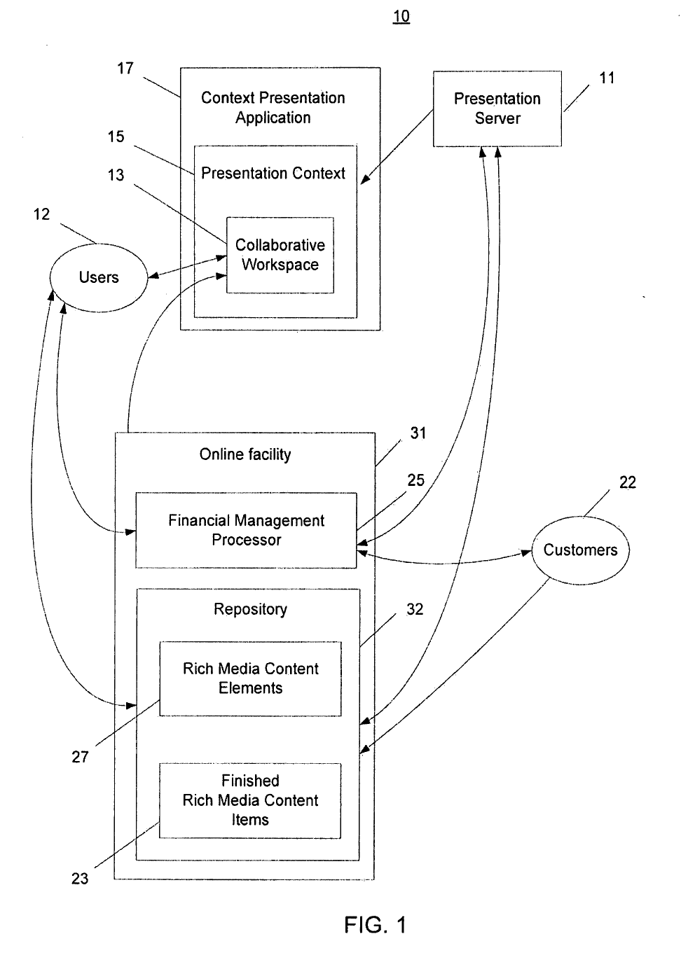

As shown in broad terms in FIG. 1, in an online collaboration system 10, items of rich media content (for example, a video clip) can be produced by a collaborative effort of multiple users. A user interacts with a collaborative workspace 13 (e.g., a rectangular window) displayed within a broader presentation context 15 (e.g., a web page) to access, review, modify, and contribute elements 27 related to the items of rich media content 23. The presentation context 15 may be provided by a presentation context application 17 (for example, a browser). The presentation context 15 is delivered from a presentation server 11 (e.g., a web server). The content presented to users 12 in the collaborative workspace 13 is provided from an online facility 31.

The online facility maintains a repository 32 of stored finished rich media content items (“RMC items”) 23 that are packaged and ready either for direct presentation to customers 22 or for delivery to parties (not shown) who repackage them, bundle them, enhance them, and present them to consumers 22. The RMC items 23 broadly include finished items of any media type other than plain text, such as video, animation, claymation, graphics, and audio productions.

The repository 32 also includes elements of rich media content (“RMC elements 27) that may be in unfinished or finished states and belong to different levels of abstraction or different forms in which the elements and items to which they may belong can be expressed. Examples of RMC elements 27 include ideas, scripts, fragments of scripts, and unfinished fragments and entire productions (e.g., unedited videos). An RMC element may be expressed in any format, such as a sound, a sound track, a video clip, or an image, a script, an outline, a storyboard, or a diagram. An RMC element need not be expressed in a rich media format but could be text. RMC elements may be produced and stored as independent elements or may be associated with (for example, incorporated in) one or more of the RMC items.

The RMC elements 27 may (but need not) be organized hierarchically to reflect their respective abstractions or forms and are usable cooperatively by the users 12 to create parts or all of the RMC items 23. For example, an RMC item in the form of a finished video advertisement may be the result of a process that began by exchange, discussion, and revision of general abstract ideas and story boards for the advertisement and portions of it. At a less abstract level, users can cooperatively work from the ideas to generate, exchange, discuss, and edit scripts and portions of scripts. The RMC item can then be produced, again by cooperative creation, exchange, and editing of RMC elements and other pieces and fragments and eventually a complete final draft of the item. Elements at other levels of abstraction can also be produced during the process. The work on the elements and the item can be done iteratively with effort being returned to the ideas even after some of the script has been written or some of the production completed. Different users and different classes of users may participate at different stages and at different levels of the work. Note that an RMC item can include elements that are not drawn from the rich media content elements stored in the repository. Other sources (not shown) can provide parts or all of the embodiments of the rich media content items.

Customers 22 are parties who can access the RMC items at no charge or in some eases purchase them from the online facility 31. The access can occur either directly or indirectly through an intermediary (not shown). For example, the online facility 31 could be controlled and hosted by a party that is independent of any customers 22 or users 12. The online facility 31 could serve as a central market maker or clearinghouse for RMC items 23 under a profit-yielding business model. The online facility 31 could also serve as a production agency (e.g., advertising agency) that accepts money bearing requests from customers 22 to produce packaged rich media items 23 that conform to specifications included in the requests (e.g., inclusion of a customer logo, adherence to a particular theme, or targeting a particular market). Requests from customers for the creation of RMC items and elements can be stored in the repository as RMC elements and made available to users for consideration and action.

Customers 22 could be any individual or enterprise that seeks RMC items or RMC elements. Customers 22 can include, for example, entities (e.g., corporations, companies, institutions, organizations, etc.) who pay to have RMC items 23 created on their behalf (e.g., advertisers), individual consumers who pay (or in some cases do not pay) to access or use RMC items 23, and distribution channels who (in some cases) pay for the right to distribute RMC items 23 (e.g., broadcast or cable television networks, web outlets, web hosts, and websites), and in other cases are paid to distribute RMC items (for example, a broadcast medium paid by an advertiser to carry advertising).

In some imp lementations of the system shown in FIG. 1, the online facility 31 enables users 12 or groups of users (not shown as groups in the figure) to compete with respect to creation of the RMC items 23 and RMC elements 27 that are eventually used to form RMC items 23 or other RMC elements 27. For example, by interacting with the workspace 13, users can view or have presented to them, RMC elements 27 and rate them according to their preferences. The ratings can be of any of a wide range of characteristics of the items, such as effectiveness, polish, professionalism, interest, creativity, and others. The ratings can be accumulated in a wide variety of ways, from simple accumulation to more complicated statistical analyses. The resulting ratings can be displayed to users or customers. Rewards may be made available to users whose work is ranked higher.

The online facility 31 also provides users 12 with a capability to engage in social networking, for example, with respect to creation of RMC elements 27 and RMC items 23, or in other ways and for other purposes. For example, through the collaborative workspace 13, users 12 can interact with the online facility 31 to collaborate with other users 12 to create RMC elements 27 and items 23. The online facility could provide an online space or place in which users and customers can network with respect to particular RMC elements, RMC items, or more generally with respect to multimedia, the process of creating it, people involved in the creation, and other topics of interest. Some networking activities might include casting calls for production of RMC, technical expertise requests, or collaboration requests associated with ideas or script elements.

The system shown in FIG. 1 could be implemented in the context of a variety of business models in which revenue is derived from various parties and paid to other parties. Customers 22 may pay for the opportunity to have their requests for RMC items 23 made available to users 12. That revenue could be reserved entirely for the operator (not shown) of the online facility or could be shared with or paid entirely to the users who are willing to respond to the requests. For example, such requests may include an idea for an advertisement including prize money for the RMC item or RMC element that is selected for an advertisement campaign. Customers 22 may also pay for licensing RMC (we sometimes will use the term RMC items or the simpler term RMC more broadly to refer both to RMC items and RMC elements and portions of them) that they have not sponsored. The licensing revenue could be shared between the online facility and the users. Users 12 may pay for different levels of membership that provide different permissions, tools, and features. Advertisers (not shown) may pay for the placement of advertisements as part of RMC or as part of the social networking part of the online facility or in other ways.

Portions of the revenue could be paid to various parties. The users 12 may be paid for RMC items 23 or elements or portions of them that form part of what is provided to customers 22. The share attributable to each user maybe calculated to reflect the relative participation of the user in the production of the item. The online facility 31 may be paid for permitting advertising or content items to be delivered to users 12 through the presentation context 15. The online facility 31 may also be paid for serving as the central market maker or clearinghouse, for storing RMC, for managing the flow of revenue and payments, and for other activities.

The host of the presentation server may be the same party or a different party from the operator of the online facility. Revenues from operation of the online facility and hosting of the presentation server may be shared by the host and the operator.

Financial arrangements that implement the business models may be governed by routine and automated processes, for example, the registration of new users 12 and new customers 22, the purchase or licensing of RMC by customers 22, or the registration of advertisers. Users 12 who contribute to the creation of RMC may be referred to as “contributors.” For example, users who do one or more of submitting initial RMC elements 27, revising or editing RMC elements 27, adding rich media or other kinds of material to RMC elements 27, grouping RMC elements 27 together, and assembling them to produce RMC items 23, may be considered contributors.

The online facility 31 provides a medium for exchange of the revenue and payments contemplated by each business model through a financial management processor 25. The system shown in FIG. 1 enables any customer 22, including individuals, to enter requests/ideas for RMC and makes those requests available to users 12 anywhere in the world to develop into RMC. Users 12 can make their RMC items 23 and RMC elements 27 available to potential customers 22, and customers 22 can view RMC that is available for distribution or sale. Customers 22 are exposed to a broad and deep range of rich media content and can obtain RMC at different costs under a variety of business models.

A wide variety of implementations of the system 10 are possible. The RMC need not be limited to video or any other particular rich media, but could include any kind of digital item, including text, images, sounds, and software. The presentation context 15 need not be a web page but could be any presentation that is suitable for the content being presented and the hardware device on which the presentation is being made, for example, a notebook computer, a workstation, a kiosk, a telephone, or any other portable or handheld device. The content need not be delivered through an IP network such as the Internet, but can be conveyed in any manner and by any medium that content can be stored or transmitted, for example, through telephony networks, Bluetooth communication, power line networks, television cable, in-home networks, and dial-up and dedicated networks.

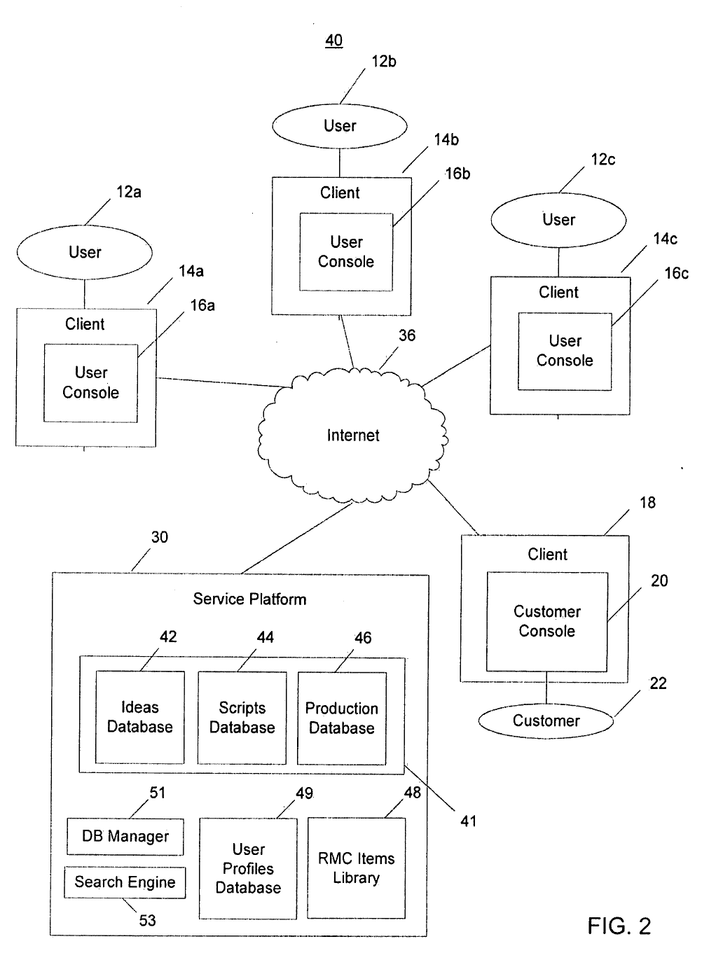

FIG. 2 shows an online collaboration system 40 that represents example implementations of the broader system 10 shown in FIG. 1. The system 40 provides a service that enables users to collaborate online at various stages of a workflow for producing RMC. The term “service” includes all or any subset of the features, systems, and methods described here for enabling the production and delivery of RMC by any party.

The system 40 includes a service platform 30, which serves as or is included as part of the online facility 31 and/or the presentation server 11 shown in FIG. 1. The service platform can be implemented as centrally located computers or a distributed set of computers with storage, processors, operating system software, and application software. The system 40 also includes client computers 14a-c and 18, a network 36 (e.g., the Internet or any other publicly or privately available network) that delivers data between the client computers 14a-c and 18 controlled, respectively, by users 12a-c (collectively referred to as “users 12”) and a customer 22. (Although the figure shows only a single customer, other customers (including potentially a very large number of other customers) may participate in the system 40.

The service platform includes a library 48 of RMC items 23 and an RMC elements database 41 for storing RMC elements 27. RMC items 23 may be generated by a workflow process that operates on one or more elements 27 over a series of stages and ends with the production of final RMC items. The RMC elements 27 that result at each of the stages may be categorized in various levels of abstraction, for example, three (or more) levels of abstraction, including ideas, scripts, and productions (not illustrated in the figure). RMC elements may be organized hierarchically with ideas representing the highest level of abstraction and productions representing the lowest level of abstraction. A workflow process typically starts with the creation of elements belonging to higher levels of abstraction, e.g., with an idea or general concept.

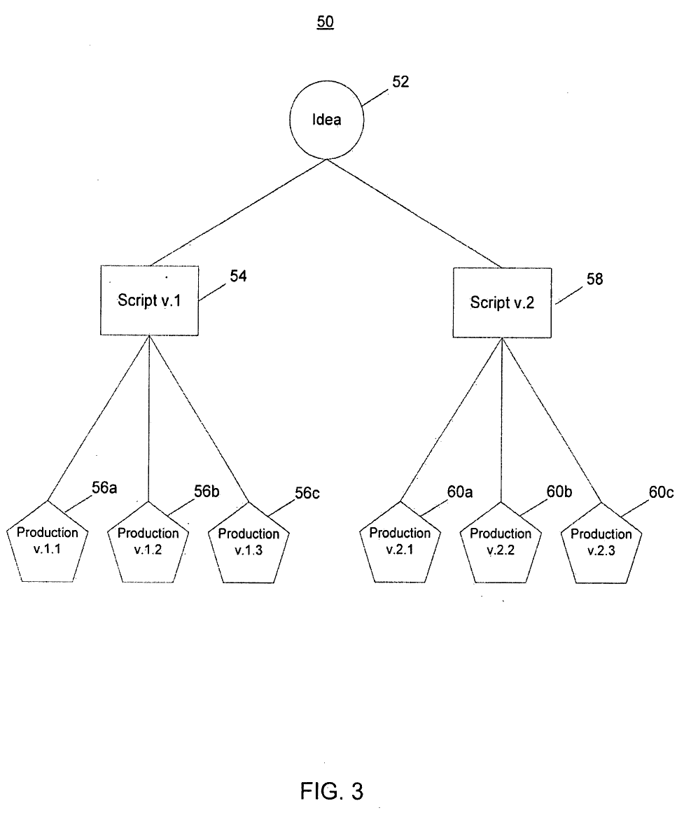

Ideas can vary in their level of detail and structure. For example, some ideas may be expressed in a single sentence while other may require a few paragraphs. An idea is then developed into a script, which is, for example, a literal word-for-word text that will eventually appear or be used verbatim in the resulting RMC item. A script may then be developed into a production, e.g., a video production, which can be further refined and edited to produce the RMC item. The platform 30 allows users 12 to collaborate at each stage of the workflow process. The workflow process, including its levels of abstraction, are described in further detail with respect to FIG. 3.

In the example implementation of FIG 2, the elements database 41 is organized into an ideas database 42, a scripts database 44, and a productions database 46 for storing elements at each abstraction level of the workflow process. The platform 30 also includes a database manager 51 for managing the contents of each database and a search engine 53 for searching elements stored in the databases.

The client computers 14a-c (collectively referred to as “client computers 14”) include user consoles 16a-c (collectively referred to as “user consoles 16”), which provide user interfaces through which the users 12 interact with the service platform 30. Through the user console 16a, a user 12a registers with the service platform 30, which in turn creates an account or profile for the user 12a, and stores the profile in the user profiles database 49. The user profile may include, for example, identification information and contact information associated with the user 12a and a record of the user's contributions to RMC. The user profile may also include personal information supplied by the user 12a, e.g., interests, hobbies, professional experience, etc. In the user console 16a, the user 12a can search for, create, modify, and view RMC elements 27 stored in any one or more of the ideas, scripts, and productions databases 42, 44, and 46 as well as RMC items 23 stored in the library 48. The user consoles (and customer consoles) can be implemented as desktop or laptop computers, mobile telephones, personal digital assistants, or any other user interactive electronic device that is stationary or mobile. Thus, participation in the platform services by users and customers can be achieved from any location anywhere in the world at any time.

Like the user console 16a, the customer console 20 provides a user interface through which the customer 22 at the client computer 18 interacts with the service platform 30. Through the customer console 20, a customer 22 registers with the service platform 30, which in turn creates an account for the customer 22. After an account has been created for a customer 22, the customer 22 can, for example, view and purchase RMC stored in the service platform 30. The customer console 20, for example, may display a list of RMC items 23 that are available for purchase and any associated economic terms for accessing, distributing, or purchasing those RMC items 23.

Using the customer console 20, the customer 22 can also submit requests to the user community for the production of RMC that does not already exist in the service platform 30. The request may include, for example, one or more ideas, which may be of varying levels of detail and may or may not specify the form of the finished item. For example, an advertiser could submit a request for a product advertisement that invites the community of users 12 to develop a television commercial that uses a previous brand mascot (e.g. a polar bear) to advertise a particular brand of soft drink (e.g. Coca-Cola™). To attract more interest from users 12, the request may also specify an award (e.g., prize money) or other incentives to be given to the group of users 12 who produce RMC that is useful to and/or selected by the customer 22. For example, the customer 22 may offer a monetary lump sum to the users 12 who produce a commercial that the customer 22 selects for an advertisement campaign. Other forms of monetary compensation and non-monetary compensation could also be arranged. Ideas included in requests that have been submitted by customers 22 are referred to as “sponsored ideas”.

Using the user console 16a, the user 12a manages relationships with other users 12b-c. In some embodiments, the user console 16a enables the user 12a to enter a list of other users who have or do not have permission to modify various RMC elements that the user 12a has originated or contributed to. The user 12a may edit the list to include additional users or change the permissions granted to existing users who are already listed. In some embodiments, the user console 16a enables a first user 12a to request permission from a second user (e.g., user 12b) to modify an element that the second user 12b had originated.

In a general workflow process 50 shown in FIG. 3, RMC is created and modified over several stages. The stages may operate, for example, on an RMC element in a successive order such that the modifications made in one stage carry over to the subsequent stage, etc. In the example implementation shown in the figure, the RMC elements 27 produced at different stages of the workflow process 50 belong to different levels of abstraction for representing finished items. These levels can be organized hierarchically and include, in order from the highest level to the lowest level, ideas, scripts, and productions.

In the example of FIG. 3, an idea 52 is an RMC element that is produced at the first stage of the workflow process 50 and belongs to the highest level of abstraction of an RMC item. At the idea stage of the workflow process 50, abstract concepts are documented and may be later used as the basis for a more comprehensive concept. An idea 52 itself is a documented expression of cognitive content originated by a single user or a group of users. In most cases, an idea 52 is embodied as a textual representation, e.g., a few sentences or paragraphs describing a concept. The idea 52 can be detailed or general and can be modified by the originator or by other users. The idea 52 can also encompass multiple related ideas, e.g., ideas for individual scenes of the same play.

The ideas database 42 stores ideas and organizes them for efficient search and retrieval by users. Users may submit comments for ideas already stored in the database 42 and/or ratings (e.g., numerical ratings based on a scale) that reflect the users preferences for the idea. An average of the ratings assigned by multiple users may be displayed along with the idea. The idea, when displayed, may also include the identity of the originator of the idea, a category to which the idea belongs, projects (e.g., scripts, productions, and finished rich media items) spawned from the idea, and any other information related to the idea.

The idea 52, once seeded, may spawn multiple scripts 54 and 58 (and others not shown). The scripts 54 and 58 provide a highly structured format for representing the idea 52. A script usually includes a detailed written description of one or more aspects of an idea, and in some instances, may be a literal word-for-word text that will be used in the finished RMC item. For example, a script may include the dialog for characters in a production or a detailed description of scenes or characters. If the rich media item is a musical production, an associated script may include a musical score and lyrics (if applicable). A script is different from an idea in that a script has a highly structured format, whereas an idea is a general description and is more conceptual. An idea, for example, may include an outline for a script. A script, in a sense, is an instance of an idea and therefore belongs to a lower level of abstraction than an idea. In other implementations, other more finely grained levels of abstraction may exist between the idea level and the script level and between the script level and the production level.

As shown in FIG. 3, an idea 52 can spawn many different scripts 54 and 58, which may or may not be different versions of each other. The scripts database 44 (shown in FIG. 2) is structured to keep track of alternative versions of scripts to make it easy for users 12 to find and modify them. Users 12 may collaborate on scripts. For example, a user 12a can revisit or edit parts of a script originated by another user 12b. The scripts database 44 keeps full revision histories for each of the scripts 54 and 58 so that users 12 can see what changes were made, when, and by whom. Furthermore, the platform 30 may provide the originator of a script (or a person who has been credited with authority over the script) with special privileges to undo changes made by other users or to revert to any revision of the script.

Through the user consoles 16, the platform 30, in some examples, provides users 12 with software tools that enable the users 12 to interactively collaborate in real-time. For example, the users 12 can see each others' revisions to a script as they are made in real time. The user consoles 16 provide the users 12 with access to online editing tools to facilitate the creation of scripts, including formatting of scripts, tracking characters within a document or series, and embedding comments into a script. The user consoles 16 provide the users 12 with information regarding which users 12 have contributed to each element of a script (e.g. 54). For example, a user 12a can see on his user console 16a details about which words in a given script were written by a user 12a, 12b, or 12c. The user 12a can optionally highlight each individual contributor to see which specific words he or she contributed. The formatting tools may provide one or more pre-formatted script templates that include sections for scene and character descriptions, dialog, action cues, A/V mode, and other information included in a script.

The character and scene descriptions may be created by a user 12a from scratch or imported from other scripts. For example, recurrent characters and scenes of a series may be imported automatically so that users 12 working on scripts for episodes of a series do not have to regenerate redundant information. Also, enabling common material, such as character and scenes, to be imported into different scripts for the same series ensures that the scripts stay true to the fundamental nature of the series.

The consoles 16 also provide controls that enable users 12 to assign ratings to scripts that are reflective of the users' preferences for the scripts. Users 12 may also rate scripts against each other. For example, alternative versions of a script can be rated in an effort to determine which version should go forward to production. A script can have associated notes, which include information related to implementing a script as a production. Examples of information that would be included in the notes of a script include the name of a song to play in the background for a specific scene described in the script, links to video clips, song clips, or media for use in a production based on the script.

At the production stage of the workflow process 50, shown across the bottom of FIG. 3, various productions 56a-c are developed from the first version of the script 54 and Various productions 60a-c are developed based on the second version of the script 58. A production is any rich media presentation or entertainment output developed from a script. Examples of productions include videos (e.g., animation, claymation, and live action, and video based in different locations); audio presentations (e.g., live recordings, synthesized music, radio shows and advertisements, comedy, book readings); web productions (e.g., FLASH animation); and other forms of rich media productions. Users 12 may collaborate to finalize a production, including adding any last audio or video touch-up to the production. Finalized productions ate stored as RMC items 23 in the library 48 shown in FIG. 2.

Although the hierarchy of FIG. 3 suggests that every item at one of the lower levels can have only one of the items at the next higher level as its parent, in some implementations more complex relationships may be permitted. For example, an idea for an automobile infomercial may spawn two scripts, one for the informational aspects of the infomercial and the other for the advertisement aspects. In that context, a given production version of a complete RMC item could have both scripts as its parent. Other relationship contexts are also possible.

At each stage of the workflow process 50, the platform 30 records the contributions to RMC elements 27 and stores a record of those contributions in the elements database 41. For example, an idea has associated information that credits the originator of the idea and any other users who contributed to the development of the idea (e.g., through additions, modifications, etc.). As the element is processed from one stage to the next, the record of contributions associated with the element is carried over such that by the time the element is processed into a RMC item 23, that RMC item 23 includes a complete record of users 12 who contributed to creation of the RMC item 23, what the contributions were, and when they were made (e.g., at what stage of the workflow process).

When users 12 enter contributions in the user consoles 16, the platform 30 automatically recognizes and records their contributions. Thus, every RMC element 27 stored in the elements database 41 and every RMC item 23 stored in the library 48 has a record showing the contributions of individual users 12. The platform 30 also creates, for each user, a record showing contributions to the creation of RMC originated or modified by the user and creative activities undertaken by the user to create RMC. The contributions record is stored as part of the user's profile in the profile database 49 (shown in FIG. 2).

The contributions stored in the record may be organized according to the creative activity undertaken by the user. For example, the contributions of the:user may be divided into the following activities: writers, composers, actors, photographers, cameramen, grips, special effects, etc. In some embodiments, individual contributions are represented as credits. For example, a user that plays an acting role in a film production would receive an “actor credit,” while a user who contributes to a script would receive a “writer credit.” Credits may be assigned different values or weights to reflect the amount and character of contributions of a particular user to a particular work product. The credits assigned to each user who contributes to RMC may be summed to produce a quantitative value that reflects the amount of contribution of each user relative to the other users. This quantitative value is referred to as the user's “contribution” and is a measure of how much that user contributed to the creation of RMC relative to other users.

A user's contribution may be based on one or more measurable factors, examples of which include: the number of words added or deleted to scripts, minutes spent working on an element 27, ranking from other users 12, and so on. Each RMC element 27 and RMC item 23 includes the numerical contributions of contributing users. The contributions may be expressed, for example, as fractions or percentages that add up to a total number (e.g., 1.0) or a total percentage (e.g., 100%). Contributions to RMC may also be calculated within categories of creative activities (e.g., idea seeding, writing, acting, etc.). For example, an RMC item 23 may show a breakdown of writing contributions, idea development contributions, acting contributions, etc. User contributions may be ranked from highest to lowest to highlight the user or users 12 who have contributed the most to a particular RMC element 27 or RMC item 23.

As described further below, the contribution attributed to a user may be used for determining how much individual contributors of RMC are compensated when a customer chooses to license or purchase the RMC using the platform 30.

Every video, script, idea, or other work product incorporated into a RMC is built into a user's profile to reflect his or her individual contributions. The credits assigned to an individual user may also be summed over different creative categories (e.g., acting, writing, seeding ideas, etc.) to produce values that are indicative of the amount of contribution that the user has made in different creative areas. For example, the values may indicate that a particular user has more acting contributions relative to writing contributions. For each category of creative activity, the platform 30 may assign scores to users that reflect the number of contributions made by the users 12 within that category relative to other users and rank the users according to their scores. This score and ranking relative to other users is referred to as “prolificity”.

The prolificity of a user indicates the global contribution of a user 12 to the platform across all RMC with respect to a particular creative activity. For example, a user with the most writing credits would have the highest score with respect to “writing contributions” and would be considered the most prolific writer among the other users 12. In some embodiments, a user's prolificity in a category of creative activity (e.g., acting) is determined by summing the number of credits assigned to the user for contributions within the a category of creative activity and dividing that number by the total number of credits assigned to all users for contributions within that category of creative activity. For example, if a total number of acting credits assigned to users 12 of the system is 25, a user. 12a who has been assigned 5 acting credits would receive a score of 5/25 or 20%. A user's prolificity differs a user's “contribution,” in that prolificity is indicative of the global contribution the user has made across multiple RMC elements 27 and RMC items 23, whereas, a contribution refers to the contributions made to an individual element 27 or RMC item 23. In some cases, a global prolificity value could even span multiple creative activities.

The platform 30 automatically assigns credit to users who interact directly with the platform through the consoles 16. To enable credit to be assigned to contributors who have not interacted directly with the site (e.g., actors in a film production), the platform 30 provides tools (through the user consoles 16) for a user to assigning proper credit to other users who have contributed to a production (e.g., a video) or other work products that the user uploads to the platform 30. After receiving the credit information from the user, the platform 30 pushes the information into the users' profiles.

The platform 30 may also maintain profiles for customers 22. Customer profiles are linked to customer accounts and may include a record of requests and associated ideas seeded by the customers 22, a record of purchased or licensed RMC items, and other information associated with services provided to the customers. Resources that could be used in the production of additional RMC for these customers, such as logos, video clips, audio, etc. that are relevant to their brand. Other specific information regarding items that the customer does NOT want in the final production (obscenity, etc.) may also be included in the profile. Customers could be rated and ranked in terms of their acquisition and commissioning habits and the rating and ranking information could be made available to users of the platform.

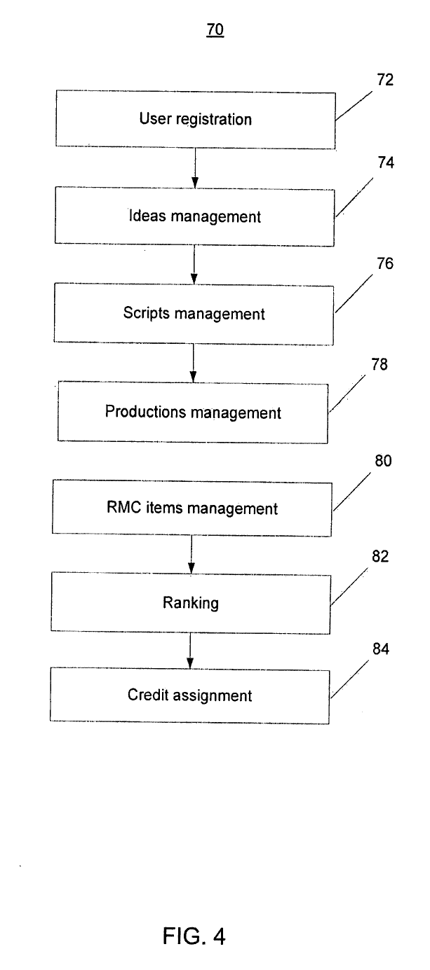

Referring to FIG. 4, the online service platform 30 performs a process 70 for enabling users 12 to create RMC through collaborative interaction. Users 12 receive access to the service by registering directly though the service's website using a simple registration process (72). During the registration process (72) users 12 provide their identification information and contact information. The platform 30 creates an account for the user that is linked to a profile that the user can customize. In their profiles, users 12 can enter information about themselves, including a short biography, a description of their talents and interests, and a list of preference such as favorite movie genre, books, and music. As described above, the profiles also include records of contributions of users 12 to elements of RMC items. The record is usually empty when the user initially registers. User accounts and profiles are stored in the profile database 49 (shown in FIG. 2). The information contained in a profile can be viewed by other users 12 of the service. Sensitive account information, such as the users home residence, age, or contact information, may not be displayed in the profile although it may be stored in the profile database 49.

Once registered, users 12 can view ideas and upload ideas of their own. The platform 30 implements an ideas management process (74) that displays ideas to users 12, enables users 12 to search ideas, e.g., by category, originator, time of posting, etc., receives comments and ratings assigned to ideas by users, and stores newly submitted ideas in the ideas database 42.

The platform 30 implements a scripts management process (76) that organizes scripts stored in the scripts database 44, including different versions of scripts that are spawned from the same idea. The scripts management process (76) provides editing tools to users 12 for editing existing scripts and for creating new scripts. The scripts management process (76) maintains: a complete revision history of scripts, contributions by users 12 to individual scripts, and user comments and ratings assigned to scripts.

The platform 30 implements a productions management process (78) that organizes and maintains productions based on scripts. The productions management process (78) provides tools for enabling users 12 to upload rich media productions (e.g., video productions). In some implementations, the productions management process (78) may provide tools for editing audio and video productions.

The platform 30 implements a RMC items management process (80) that organizes and maintains RMC items formed from finalized productions. The management process 80 maintains complete revision histories for RMC items and records describing the individual contributions of users 12 to the RMC items. The management process (80) also provides tools that enable contributors of RMC items to make their items available to potential customers.

As part of the collaborative process 70, the platform 30 implements a ranking process (82) that collects and maintains comments and rankings submitted by users for ideas, scripts, productions and RMC items. The ranking process (82) may calculate an average ranking for each stored element or RMC items, which can be displayed with the element and used by the search engine to order elements or RMC items returned in a search. Rankings may be based on one or more of the perceived quality of the RMC item and the popularity of the RMC items (e.g., the number of times it has been viewed by users 12).

As part of the collaborative process 70, the platform 30 also implements a credit assignment process (84) that assigns credit to users 12 for their contributions to RMC elements 27 of RMC items 23. The credit assignment process (84) automatically recognizes and records written contributions by users 12, for example, contributions to ideas and scripts. The credit assignment process (84) also provides tools for enabling users 12 to assign credit to contributors of uploaded work products (e.g., video productions) whose contributions did not entail interaction with the platform 30. For example, the credit assignment process (84) enables a user who uploads a video to a assign credit to actors featured in the video as well as cameramen, grips, special-effects artists, etc.

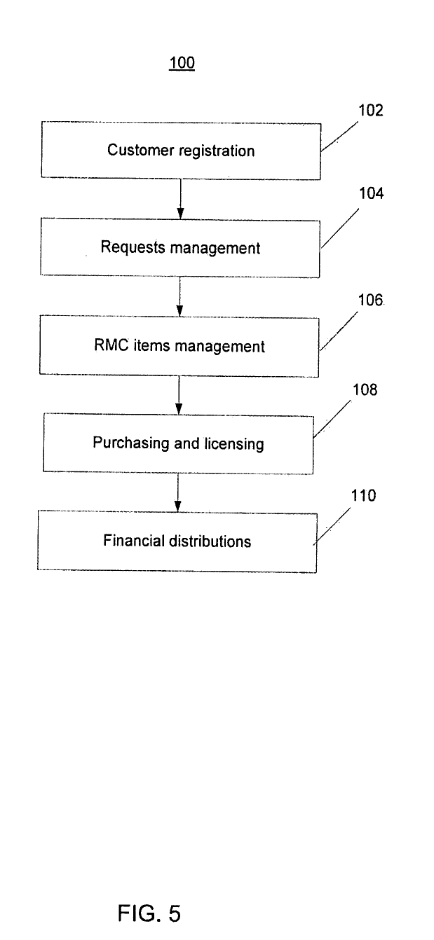

Referring to FIG. 5, the service platform 30 performs a process 100 for enabling customers 22 to obtain RMC items 23 produced by the collaborative process 70 of FIG. 4. A registration process (102) provides customers 22 with a registration screen for registering an account with the service. To create the account, the customer 22 enters requested information (e.g., identification and contact information) into the customer console 20. During the registration process (102) the customer 22 establishes payment and invoicing terms with the service to be scheduled with regular payment and billing cycles. The financial management processor 25 of service platform 30 handles scheduling of payments and invoicing functions. In some embodiments, the financial management processor 25 is integrated with mainstream transaction providers such as VeriSign® or PayPal®. For example, the financial management processor 25 may use a mainstream transaction provider for smaller-scale publishers. The financial management processor 25 may also provision an account in advance.

During the registration process (102), the customer console 20 prompts the customer 22 to define a set of information about themselves and/or the entity they represent. The information entered by a customer 22 includes, but is not limited to, their name and contact information, a description of their company, organization, etc., a description of their products and services, and brands and/or logos and/or media elements to be used in listing their products. Through the customer console 20, the registration process (102) also enables the customer 22 to configure their merchant payment terms (e.g., their PayPal, or credit card account information) from which cleared transactions are to be deducted.

The platform 30 implements a request process (104) that invites the customer 22 to submit requests to users of the service to produce RMC items 23 that satisfy a given set of constraints. The request includes an idea, e.g., an idea for a commercial using the customer's brand, and other constraints that the customer 22 may have. For example, in the request, the customer 22 may specify that a specific character or theme be used or that the eventual RMC item 23 conforms to a particular genre of production (e.g., television commercial vs. radio commercial).

To provide an incentive to users to develop RMC items 23 in response to the request, the customer 22 may advertise an award to be given to the contributors of the RMC item that the customer 22 judges to be the best and/or decides to use, for example, in an advertising campaign. The award may be monetary or non-monetary. After the request is submitted, the platform 30 associates the requests with the customer's account and stores the request as a “sponsored idea” in the ideas database 42, from which it may be accessed by users 12 of the service. In some embodiments, the platform 30 features sponsored ideas more prominently than other ideas to attract more attention from users 12.

The platform 30 implements an RMC items management process (106) for organizing and maintaining RMC items 23 created by users 12 in response to customers' requests. In some embodiments, the platform 30 notifies the customer 22 as RMC items 23 are submitted by users in response to the customer's request. The process (106) enables customers 22 to view the RMC items 23 and rate the items 23 on a preference scale.

The platform 30 implements a purchasing and licensing process (108) that handles financial transactions involved with selling and licensing RMC items 23 to customers 22. The RMC items 23 can include items submitted in response to a customer's request and items based on ideas that were not sponsored by the customer 22. The process (108) ensures that appropriate licensing fees and or other fees are paid by the customer 22 in return for the platform 30 providing the RMC items 23 to the customer 22. As will be described later in further detail, the entity that owns and operates the platform 30 may take a cut of the licensing fees paid by the customer 22, with the remainder of the fees being distributed among the contributors of the licensed RMC item.

The financial distributions process (110) ensures that payments for licensed or purchased RMC items are distributed fairly among the users 21 who contributed to the creation of the RMC items. In some embodiments, the payments may be allocated to individual contributors according their amount of contribution to the RMC item relative to other contributors. Payments may be allocated to three different groups of contributors: “major contributors”, “contributors”, and “minor contributors”, to which individuals are assigned depending on their level of contribution to an RMC item, and shared equally between the individuals within each of the groups.

For example, to assign individual users to one of the contributor groups, the process (110) ranks the user contributions from highest to lowest and starting with the highest contribution, the process (110) sums the contributions in descending order until the sum is greater than or equal to a first value (e.g., 50%). The users associated with first set of summed contributions are then designated as “major contributors.” The process (110) continues to add remaining contributions to the sum until the sum is greater than or equal to a second value (e.g., 90%) The users associated with these remaining contributions are then designated as “regular contributors” or simply “contributors.” The process (110) then designates the users associated with the rest of the remaining contributions as “minor contributors.” After assigning individual contributors to their respective contributor groups, the process (110) allocates the total compensation among the groups and then among individual users.

The process (110) first divides the total amount of compensation according the relative cumulative sums of contributions of the users assigned to each contributor group. The amount of compensation allocated to a contributor group is then evenly distributed over the users assigned to that group. For example if the sums associated with major, regular, and minor contributors are 50%, 40%, and 10%, respectively, an amount equal to 50% of the total compensation is split evenly between the users who are designated as major contributors, 40% of the total compensation is split evenly between the users who are designated as regular contributors, and 10% of:the total compensation is split evenly between the users who are designated as minor contributors.

The following example illustrates the algorithm, described above, for compensating users based on their relative contributions to an RMC item 23. In Table 1, the relative contributions of six users to an RMC item 23, which are shown in the second column, are ranked in order from highest to lowest and sum to 100%.

TABLE 1

| User | Contribution | Contributor Group | Share of Compensation |
|---|---|---|---|
| 1 | 40% | Major | 30% |
| 2 | 20% | Major | 30% |
| 3 | 15% | Regular | 11.7% |
| 4 | 12% | Regular | 11.7% |
| 5 | 8% | Regular | 11.7% |
| 6 | 5% | Minor | 5% |

As described above, to group the users into one of the three contributor groups (major, regular, and minor) the process starts from the highest contribution (i.e., 40%) and takes a cumulative sum with successive contributions until the sum reaches or exceeds 50%. The users associated with the first set of summed contributions are designated as major contributors. In this case, the users associated with the first two highest-ranked contributions (i.e., 40% and 20%) are major contributors since the sum of their contributions (i.e., 60%) exceeds 50%. Remaining contributions are successively added to the sum of 60% in descending order of ranking until the resulting cumulative sum.is equal or in excess to 90%. In this case, with the addition of next three contributions 15%, 120%, and 8%, the cumulative sum (60% in this example) reaches 95%, which exceeds 90%. Thus, the users associated with the third, fourth, and fifth-ranked contributions are regular contributors. The remaining user is: a minor contributor.

The total amount of compensation is allocated to each of the three groups according to the sum of contributions of users belonging to each group. In this case, the major contributor group is allocated 60% of the total compensation (i.e., 40%+20%); the regular contributor group is allocated 35% of the total compensation (i.e., 15%+12%+8%); and the minor contributor group is allocated 5% of the total compensation. The. amount allocated to a contributor group is then split evenly between the users assigned to that group. For example, 60% of the total compensation allocated to the major contributors is split equally between users 1 and 2. Similarly, 35% of the total compensation allocated to regular contributors is split evenly between users 3, 4, and 5. The remaining 5% of the total compensation that is allocated to minor contributors is provided to the user 6, who is the only minor contributor.

The process (110) may use other algorithms to distribute compensation between users who contribute to the creation RMC items 23. The process (110) may also distribute payments according to legal agreements entered into by users. Payments may be distributed directly to users' bank accounts, e.g., Via direct deposit, or mailed to recipients as a check or money order.

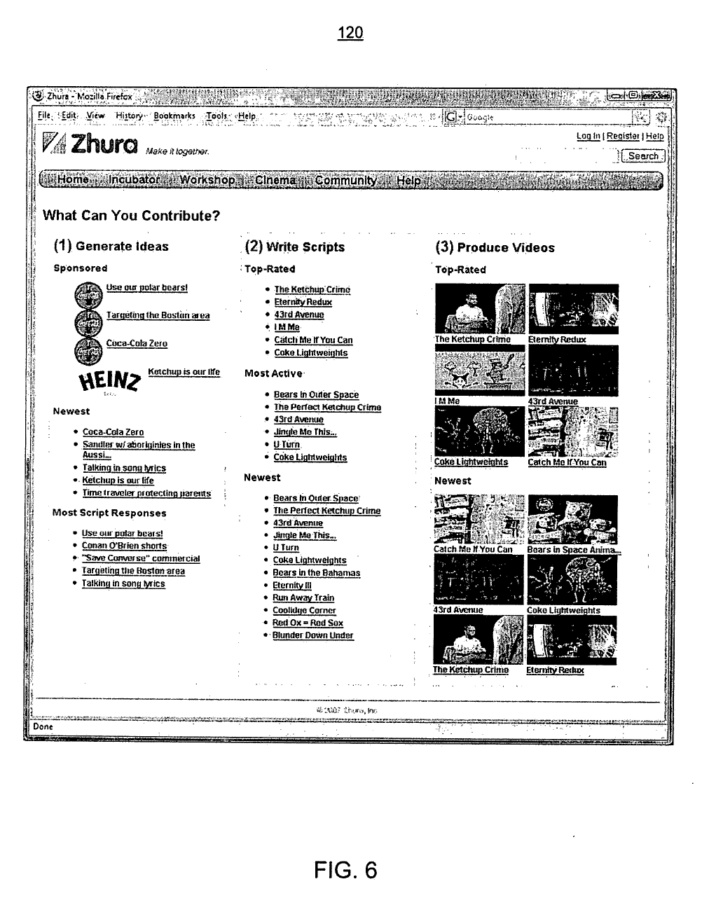

FIGS. 6-9 show screenshots of exemplary tools provided by the user consoles 16 for performing the process 70 described in FIG. 4. A wide variety of other user interface arrangements, elements, and features could be used.

An example of an initial dashboard or homepage 120 is shown in FIG. 6. The homepage 120 includes a welcome message, e.g., “What Can You Contribute,” a section for ideas, a section for scripts, and a section for productions. Each of the sections includes titles of the RMC elements 27 and RMC items 23 contained therein. Users 12 can view the RMC elements 27 and RMC items 23 by clicking on their titles. As shown in the screenshots, the productions are RMC items 23. In other embodiments, the productions could also be RMC elements 27.

The ideas section includes separate subsections for sponsored ideas, the newest ideas, and ideas that have received the most script responses. The script section includes separate subsections for the top-rate scripts, the most active scripts (e.g., scripts for which user contribution is the highest), and the newest scripts. The production section includes a subsection that lists the top-rated productions and a subsection that fists the newest productions. At the top of the page 120, a menu bar includes a link to the homepage (i.e., “Home”), a link to an ideas page (i.e., “Incubator”) where users can submit, view, modify, and rate ideas, a link to a scripts page (i.e., “Workshop”), where users can view, start, modify, and rate scripts based on ideas, a link to a productions page (i.e., “Cinema”), where users can upload, edit, view, and rate productions, a link to a community page (i.e. “Community”) where users can create and update their own profiles, view other users profiles, and contact other users, e.g., via messaging, email, and other forms of web-communication, and finally the menu bar includes a link to a help:page (i.e., “Help”) where users can access technical support.

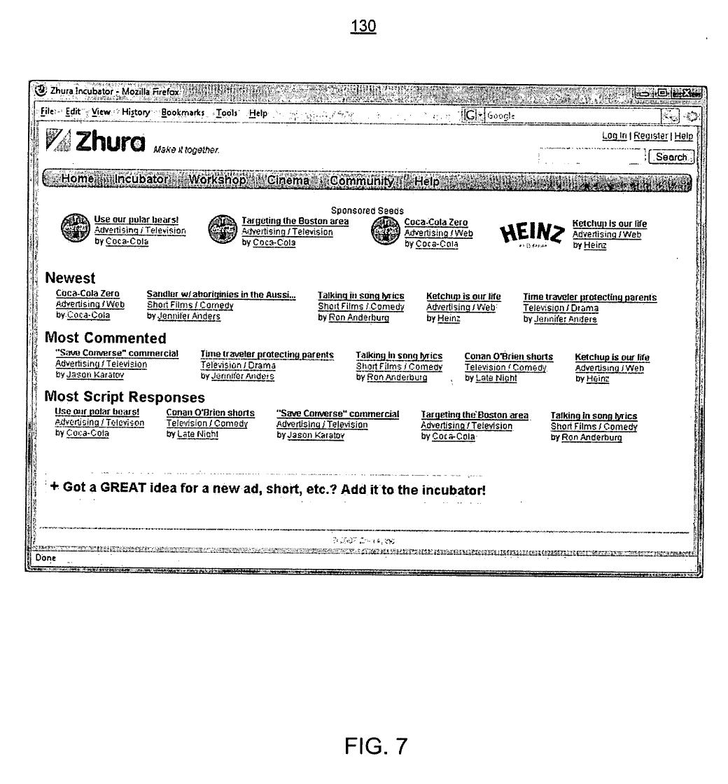

An example of an ideas page 130 is shown in FIG. 7. The ideas page 130 includes a listing of submitted ideas, with sponsored ideas prominently displayed in the top section of the page 130. By clicking on a title, a user can view the idea. By clicking on the prompt at the bottom of the page 130, a user can submit a new idea. A user may also search the ideas database 42 by entering one or more keywords into the search prompt shown at the top, right-hand corner of the page 130.

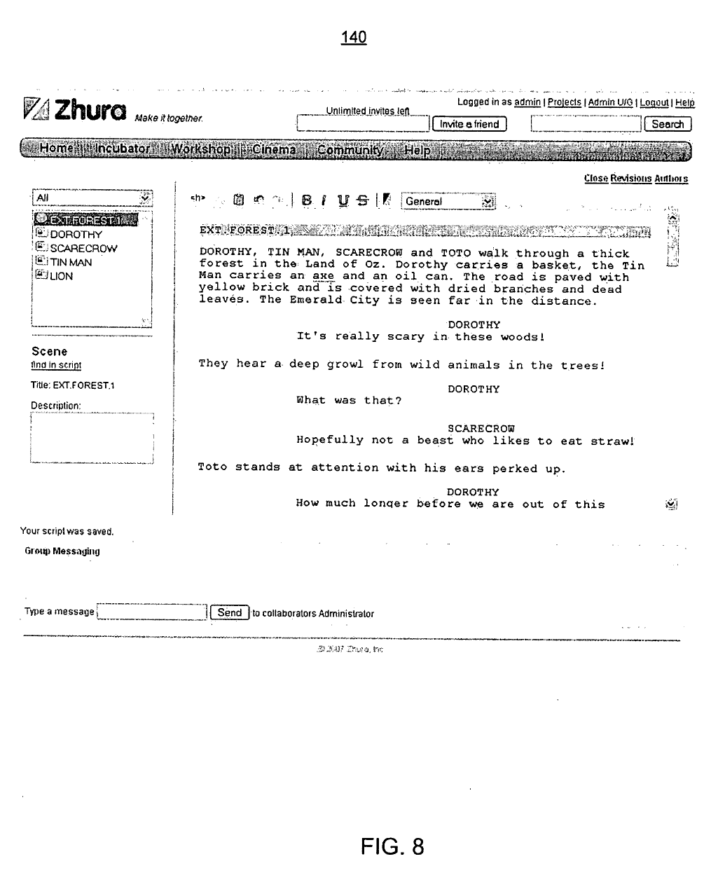

An example of script page. 140 is shown in FIG. 8. The page 140 includes window that: displays the text of the script and a toolbar for formatting the text. The left-hand side of the page 140 includes links to descriptions of the characters that are invoked by the script. As described above, these descriptions could be imported by other scripts that use the same characters. The page 140 also includes a link to the scenes described in the script. At the bottom of the page 140, a messaging tool enables users to collaborate with other users who are working on the script. At the top of the page 140, a search tool enables users to search for scripts by one or more key words. The page 140 also enables a user, e.g., an originator of a script, to invite other users to collaborate on the script. In some embodiments, an originator of a script can have complete control over who is allowed to contribute to his or her script.

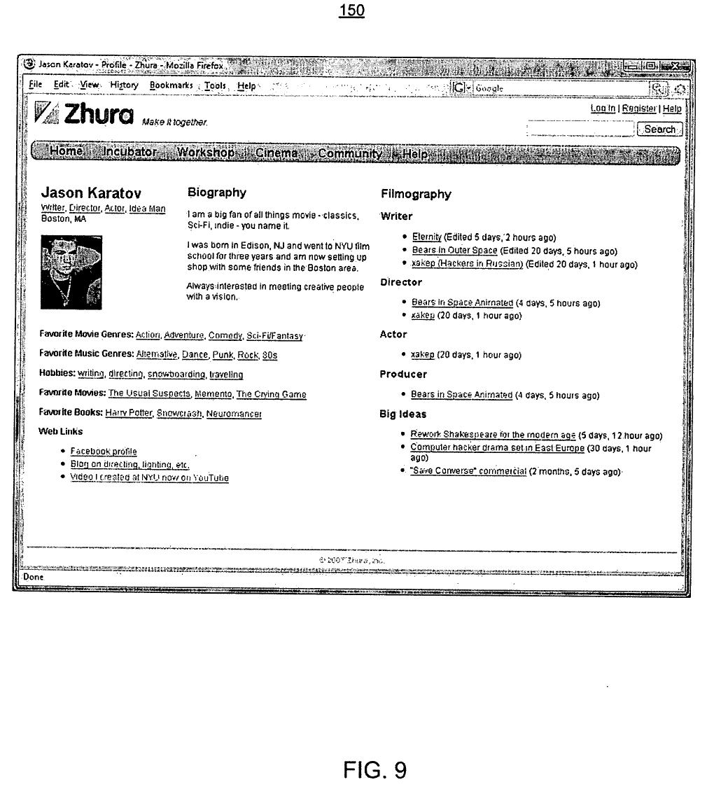

An example of a profile page 150 within the profiles database 49 is shown in FIG. 9. The profile page 150 displays a profile of user. The profile includes the user's name and location and a picture of the user. The profile includes a brief biography of the user and a list of interests, hobbies, and links to other websites that provide further information about the user or his/her interests. The profile also includes a record or “filmography” of the user's contributions to RMC items 23 and elements created using the platform 30. The filmography shows the names of the RMC items 23 and elements to which the user has contributed, with the names organized according to categories of creative activity, e.g., writing, directing, acting, producing, and brainstorming ideas. Next to the name of each RMC item 23 and element 27, information indicates how long ago the user contributed to the RMC item 23 or element 27 with respect to the category of creative activity.

The online collaborative system 40 supports several revenue opportunities. The service can collect revenue from both users and customers 22. For example, the service may charge registration fees and/or subscription fees to users and customers 22 The service can collect advertising revenue from customers 22 in return for placing advertisements sponsored by the customers 22 on different pages of the web site. Examples of these advertisements include banner ads and pop-ups. The service can charge “seeding fees” to customers 22 for posting their requests to the community to develop sponsored ideas. The service may charge customers 22 licensing fees in exchange for allowing the customers 22 to use RMC items, e.g., in an advertising or video campaign, or distribute the items to other outlets. The. licensing of RMC items to customers 22 may be exclusive or non-exclusive. The service can charge customers 22, e.g., advertisers, a fee in exchange for providing the customers 22 with demographic information collected from user profiles. For example, information from user profiles can be used to determine the demographics of people who work on various types of sponsored advertising campaigns, productions, and other RMC items 23. Advertisers may then use this information to better target specific demographics.

The service may also derive revenue from users. For example in some embodiments, the service offers a professional membership to users 12 in exchange for a fee or as a subscription with monthly or annual billing. Users having a professional membership, referred to as “professional members,” have control over who contributes to scripts that the users originate. The service provides professional members with tools to invite other users to collaborate on their scripts and grant permission to users requesting permission to edit or add to their scripts. When deciding whether to invite or grant a user permission to collaborate on a script, a professional member may consider information in the user's profile or the rating assigned to Work products to which the user has contributed.

The components of the systems 10 and 40 can be implemented, at least in part, in digital electronic circuitry, analog electronic circuitry, or in computer hardware, firmware, software, or in combinations of them. The components of the systems 10 and 40 can be implemented as a computer program product, i.e., a computer program tangibly embodied in an information carrier, e.g., in a machine-readable storage device or in a propagated signal, for execution by, or to control the operation of data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps associated with content distribution system 10 can be performed by one or more programmable processors executing a computer program to perform functions of the invention by operating on input data and generating an output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one r more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

Other embodiments are also within the scope of the following claims.

For example, although we describe RMC as comprising two kinds, RMC elements and RMC items, additional categorizations of RMC could be made and used in the system. For example, RMC elements could be considered as raw and finished, and RMC items could be considered as components and complete. Other RMC categories may be useful to establish, and the term RMC and sometimes RMC items is used here to refer to any categorizations of RMC used with such a system. We sometimes: use the term finished RMC to mean items or elements that are in a form suitable:for distribution and RMC fragments or portions to refer to items or elements that are not in a form suitable for distribution either because they are not finished or because they each represent less than all of a work to be distributed. Thus, an RMC portion may be finished or unfinished.

What is claimed is:

1. A method comprising
providing a publicly accessible online facility that enables users to create finished rich media content (RMC) by collaboratively engaging in activities to create RMC portions related to the finished RMC, the RMC portions being made accessible to the users in different predefined levels of abstraction in which the finished RMC can be expressed.

2. The method of claim 1 in which the online facility also enables the users to compete with respect to the creation of the RMC portions.

3. The method of claim 1 in which the online facility also enables the users to engage in social networking with respect to the creation of the RMC portions.

4. The method of claim 1 in which the levels of abstraction include ideas and expressions of the ideas in forms that are not finished RMC.

5. The method of claim 4 in which the expressions of the ideas comprise at least one of scripts, essays, song lyrics, and speeches.

6. The method of claim 1 in which each of at least one of the elements that belongs to a higher level of abstraction is associated with one or more element at a lower level of abstraction.

7. The method of claim 1 in which each of at least one of the elements that belongs to a higher level of abstraction is associated with more than one element at a lower level of abstraction.

8. The method of claim 1 in which at least one of the elements that belongs to a lower level of abstraction can be generated using multiple elements at a high level of abstraction.

9. A method comprising:
making available to users of a publicly accessible online facility a hierarchy of rich media content (RMC) portions that are made available in two or more predefined abstraction levels associated with rich media content (RMC), the RMC portions being usable cooperatively by the users to create finished RMC.

10. The method of claim 9, wherein the hierarchy of portions includes ideas, scripts, and entertainment productions.

11. The method of claim 9, further comprising:
enabling users to assign rankings to the portions based on the users' preferences.

12. The method of claim 9, further comprising enabling users to edit each of the RMC portions.

13. The method of claim 9, further comprising:
providing the users with tools to engage in social networking with respect to the creation of the RMC portions and the finished RMC.

14. A method comprising
providing through a publicly accessible online facility an interactive, searchable, ranked repository of ideas that can be used in the creation of rich media content (RMC).

15. The method of claim 14, further comprising:
storing in the repository, an idea submitted as part of a money-bearing request by an entity for the production of rich media content (RMC) that is based on the idea.

16. The method of claim 14, further comprising:
displaying an idea and associated information stored in the repository on a user-interface, the associated information including at least one of an identity of the originator of the idea, a category to which the idea belongs, and portions of RMC that are spawned from the idea.

17. The method of claim 14, further comprising:
displaying comments pertaining to ideas stored in the repository, the comments being submitted by users of the online facility.

18. The method of claim 14, further comprising:
providing a financial incentive to users to develop RMC based on an idea stored in the repository.

19. A method comprising
based on information about activities performed by respective contributors to, and information about portions of rich media content (RMC), calculating values representing relative contributions of the contributors,
providing the values for use in compensating the contributors, and
providing the values for use in crediting the contributors.

20. The method of claim 19, wherein calculating values comprises
calculating sums of individual contributions of each of the contributors to a portion of RMC; and
calculating ratios of the sums to a total sum of individual contributions made by all of the contributors to the RMC portion, the ratios representing the relative contributions of the contributors.

21. The method of claim 19, further comprising:
assigning the contributors to multiple groups based on the values associated with the contributors, each of the groups representing a level of contribution to the portion of RMC; and
allocating compensation to contributors based on their assignments to the groups.

22. The method of claim 21, wherein the groups of contributors comprise major contributors, regular contributors, and minor contributors.

23. The method of claim 21, wherein allocating compensation further comprises:
allocating portions of the compensation to the groups; and
dividing the portions equally between contributors within each of the groups.

24. The method of claim 19, wherein the portion of RMC is created using a publicly accessible online facility, and further comprising:
allocating a portion of the compensation to a party that controls the online facility.

25. The method of claim 19, further comprising:
automatically assigning credit to contributors for their contributions to the portion of RMC.

26. A method comprising
publishing a raking of users of a publicly accessible online facility with respect to their relative performance on types of creative activities, undertaken through the online facility, to produce portions of rich media content.(RMC).

27. The method of claim 26, wherein the ranking comprises numerical scores assigned to the users, the numerical scores corresponding to the number of contributions made by the users within a category of creative activity relative to other users.

28. The method of claim 26, wherein the ranking of the users indicates the global contribution of each of the users to the online facility across all elements and RMC with respect to a particular creative activity.

29. The method of claim 26, further comprising:
calculating sums of a number of credits assigned to the users for their contributions within a category of the creative activities;
and dividing the sums by the total number of credits assigned to all users for contributions within that category of creative activity, the ranking being determined based on the results of the dividing.

30. The method of claim 26, wherein a particular creative activity is selected from the group consisting of: generating ideas, writing, directing, acting, filming, producing, and singing.

31. The method of claim 26, further wherein the ranking is based on one or more of: the perceived quality and the popularity of the RMC contributed to by the users.

32. A method comprising
making available to users through a publicly accessible online facility, information about common elements that can be used in each portion of a group of portions of rich media content (RMC) to be created collaboratively by users of the online facility.

33. The method of claim 32, wherein the elements belong to different predefined levels of abstraction in which the portions of RMC can be expressed.

34. The method of claim 32, wherein the elements include ideas and expressions of the ideas in forms that are not finished items.

35. The method of claim 34, wherein the expressions of the ideas comprise at least one of scripts, essays, song lyrics, speeches, audio productions, musical productions, and video productions.

36. The method of claim 34, further comprising:
enabling users to assign rankings to the portions of RMC.

37. The method of claim 34, further comprising:
enabling users to edit the same portion.

38. The method of claim 34, further comprising:
enabling the users to compete with respect to the creation of the portions.

39. The method of claim 34, wherein two or more items of the group of portions include alternative versions based on a common element.

40. The method of claim 34, further comprising:
enabling the users to engage in social networking, through the online facility, with respect to the creation of the RMC portions.
